(19) United States
(12) Patent Application Publication
(10) Pub. No.: US 2002/0070074 A1
(43) Pub. Date: Jun. 13, 2002

(54) Vibration damping article and method of using same to damp vibration

(76) Inventor: Anthony C. Bongiovi JR., Fort Lauderdale, FL (US)

Correspondence Address: Office of Intellectual Property Counsel, 3M Innovative Properties Company, PO Box 33427, St. Paul, MN, 55133-3427, US

(21) Appl. No.: 09/921,831

(22) Filed: Aug. 3, 2001

Related U.S. Application Data
(60) Provisional application No. 60/223,010, filed on Aug. 4, 2000.

(51) Int. Cl. F16F 7/00; F16F 15/00

(52) U.S. Cl. 181/207

(57) ABSTRACT

A vibration damping article includes a) a substrate having a density of at least about 10 lb/ft³ and a flexural modulus and a flexural modulus of at least about 110,000 psi; and b) a foam layer bonded to said substrate, said foam layer having a loss tangent of greater than about 0.2 in the range of 10 to 20,000 Hz and a compressive storage modulus of from about 10⁵ dynes/cm² to about 10¹⁰ dynes/cm² in the range of 10 to 20,000 Hz.

### BACKGROUND OF THE INVENTION

The invention is directed to damping vibration.

Many structures vibrate in response to a sufficient stimulus. Structures such as boat hulls and airplane fuselages frequently experience structural vibration due to sources of vibrations including, e.g., motors, generators, propellers and rudders. Structural vibration can lead to audible airborne noise, which can be annoying to human beings, particularly when the airborne noise is present in close quarters such as those found in boats and on airplanes.

Efforts to damp vibration include applying a viscoelastic material to an article experiencing resonant vibrations. The viscoelastic material absorbs and dissipates the vibrational energy, thereby damping the vibrations and reducing any noise associated therewith. Sometimes the viscoelastic material is applied to the article alone. Such structures are often referred to as “free layer” damping structures. Improved damping can often be obtained when the viscoelastic material is sandwiched between the article and a relatively stiff substrate. Such structures are often referred to as “constrained layer” damping structures. Examples of other structures that have been developed to damp vibration include a thin, flexible metal foil sheet bonded to a relatively thicker rubbery foam layer.

It is often desirable to damp vibrations in metal and composite structures. Metals have specific resonant frequencies at which most of the vibration response occurs. As a result, a damping material can be “tuned” to the specific frequency of the metal to damp the vibration of the metal. Composite materials, such as the fiberglass composites used in some boat hulls, in contrast, often exhibit resonance frequencies over a broad spectrum. As a result, it is more difficult to damp vibrations in composite materials.

### SUMMARY

The invention features an article that is capable of damping vibrations in structures prone to vibration, which, in turn, reduces the airborne noise generated by the structure. The damping article is particularly well suited to damping vibrations in composite structures such as fiberglass boat hulls.

In one embodiment a vibration damping article is provided comprising:

a) a substrate having a density of at least about 10 lb/ft³ and a flexural modulus of at least about 110,000 psi; and

b) a foam layer bonded to said substrate, said foam layer having a loss tangent of greater than about 0.2 in the range of 10 to 20,000 Hz and a compressive storage modulus of from about 10⁵ dynes/cm² to about 10¹⁰ dynes/cm² in the range of 10 to 20,000 Hz.

The damping article can be constructed to be water stable and nonabsorbing, i.e., does not absorb oil and water to an extent that would deteriorate the physical properties or vibration damping capabilities of the damping article.

The invention also provides a user with the ability to select from a variety of damping articles having different densities to optimize the vibration damping for a particular vibration damping application.

Structures such as boats and airplanes can be constructed with the damping article(s) to exhibit decreased vibrations and airborne noises relative to structures that do not include the damping article. Accordingly, the present invention also provides a method of damping vibration, said method comprising:

a) applying an adhesive composition to at least one of:

a structure capable of vibrating; and

an article comprising:

i) a substrate having a density of at least about 10 lb/ft³ and a flexural modulus of at least about 110,000 psi; and

ii) a foam layer bonded to said substrate, said foam layer having a loss tangent of greater than about 0.2 in the range of 10 to 20,000 Hz and a compressive storage modulus of from about 10⁵ dynes/cm² to about 10¹⁰ dynes/cm² in the range of 10 to 20,000 Hz; and

b) contacting said structure with said article such that said article becomes bonded to said structure through said adhesive composition.

The present invention also provides a boat hull comprising:

a composite comprising resin and fiberglass; and

the article as described herein bonded to said composite.

In a preferred embodiment, the boat hull further comprising a resin impregnated fiberglass web disposed on at least a portion of (more preferably over the entire surface of) the article.

Other features of the invention will be apparent from the following description of preferred embodiments thereof, and from the claims.

### BRIEF DESCRIPTION OF THE DRAWINGS

FIG. 1 is side view of a damping article of the present invention.

FIG. 2 is a side view of the damping article of FIG. 1 attached to a structure.

FIG. 3 is a side view of a coating covering the damping article of FIG. 2.

FIG. 4 is a cross section of a boat hull that includes a damping article of the present invention.

FIG. 5 is a side view of a number of damping articles of the present invention attached to a structure.

FIG. 6 is a side view of a number of damping articles of the present invention attached to a structure.

### DETAILED DESCRIPTION

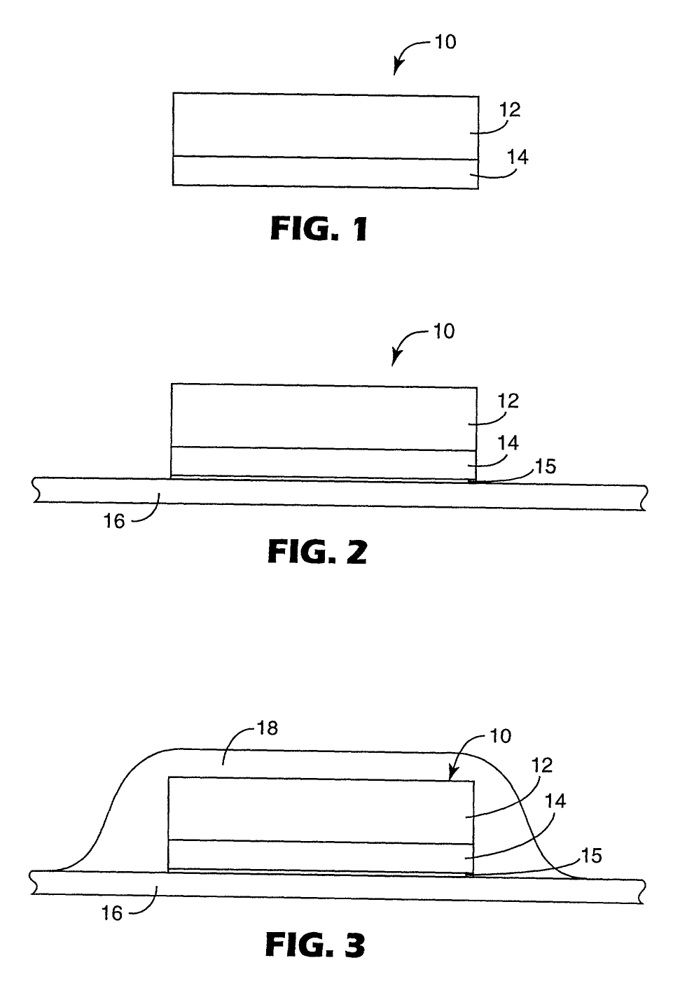

FIGS. 1-3 illustrate an embodiment of a vibration damping article 10 that includes a rigid substrate 12, i.e., a constraining layer, and a resilient foam layer 14, i.e., a vibration absorbing damping layer, bonded to the rigid substrate 12.

The substrate of the constraining layer is rigid and has a density of at least about 10 lb/ft³. The substrate can be constructed to have a density selected from a broad range of densities including, e.g., a density of at least about 20 lb/ft³, at least about 35 lb/ft³, at least about 40 lb/ft³, from about 20 lb/ft³ to about 80 lb/ft³, and from about 60 lb/ft³ to about 70 lb/ft³. The substrate also has a flexural modulus of at least about 110,000 psi (measured according to ASTM test method D790). The substrate can also be constructed to have a flexural modulus of at least about 300,000, at least about 400,000 psi and at least about 450,000 psi. Preferably the substrate does not absorb liquids, e.g., moisture, water and oil, to a degree that would degrade the physical properties of the substrate or the damping capabilities of the damping article made therefrom.

The substrate of the constraining layer is preferably a composite formed from a polymer and a fibrous component.

A preferred polymer is polyurethane. The composite can be in the form of a closed cell foam such as polyurethane foam. Polyurethane foams may be formed by methods known to those of skilled in the art and are generally formed by reacting a polyisocyanate with a polyol including, e.g., a polyether containing hydroxyl groups or a polyester containing hydroxyl groups, in the presence of a blowing agent, a catalyst and a surfactant. The blowing agent may be CO₂ generated by a water/isocyanate reaction. Other blowing agents include methylene chloride, hydrofluorochlorocarbons, partially or fully fluorinated hydrocarbons, or volatile hydrocarbons, whereby heat generated when the polyisocyanate reacts with the polyol evaporates the blowing agent so it passes through the liquid mixture forming bubbles therein. For applications in which the damping article may be exposed to water, the polyol is preferably a polyether polyol.

The fibrous component can be included in the composite to alter the properties, e.g., strength, of the composite relative to a composite that does not include the fibrous component. The fibrous component is combined with the polymer of the composite such that the fibrous component is dispersed randomly or uniformly including, e.g., in layers, substantially homogeneously or a combination thereof, throughout the resulting composite. Suitable forms of fibrous components include, e.g., fibers, filaments, rovings, threads, strands, yarns, cords, and woven and nonwoven mats and webs. Suitable fibrous materials include, e.g., metal such as aluminum oxide, magnesium and steel, fiberglass, natural organic fibrous materials such as wool, silk, cotton and cellulose, and synthetic fibrous materials such as polyvinyl alcohol, nylon, polyester, rayon, polyamide including, e.g., aromatic polyamide fibers available under the trade designation Kevlar from E. I. DuPont (Delaware), acrylic, polyolefin, aramid and phenol, and combinations thereof. Preferably the fibrous component is fiberglass or Kevlar aramid fibers.

The fibrous component can be included in the composite in amounts effective to achieve a composite having a desired property. Increasing the amount of fibrous components present in the composite, for example, can increase the strength of the composite. Fibrous component may be included in an amount of up to about 35% by weight of the composite.

Fillers may also be included in the composite. Fillers can perform a number of functions including, e.g., increasing the strength of the composite, adding mass to the composite, or a combination thereof. Suitable fillers include, e.g. talc, calcium carbonate, zinc oxide, titanium dioxide, diatomaceous earth, carbon, metal including, e.g., heavy metals. Fillers are useful in a variety of forms including, e.g., powder, flakes, granules, shavings, and combinations thereof. Fillers can be added to the composition of the composite in amounts effective to achieve a composite having desired properties. The fillers may be included in an amount of up to about b 20% by weight of the composite.

The composite can also include other additives including, e.g., colorants, toughening agents, fire retardants, antioxidants, antistatic agents and plasticizers.

Examples of methods of making closed cell foam composites of polyurethane and fiberglass are known in the art and are reported for example in U.S. Pat. No. 5,306,735 and in “Szycher's Handbook of Polyurethanes”, Szycher, Michael M., CRC Press.

Useful closed cell fiberglass reinforced polyurethane foam composites are commercially available under the trade designation “XTREME” including for example “XTREME 1000”, “XTREME 1500”, “XTREME 2000”, and “XTREME 2500” from Penske Composites (Mount Juliet, Tenn.).

Other suitable substrate materials include, e.g., polymers, metals, wood, and combinations thereof.

The substrate can have any desired thickness, i.e., the dimension of the substrate extending generally at an angle that is perpendicular to the surface of the structure to be damped (i.e., the surface on which the damping article that includes the substrate is attached). The thickness of the substrate can be selected based upon variables associated with the application including, e.g., the amount of vibration and the vibration frequency. Preferably the substrate has a thickness of at least about 0.125 in. Other useful substrates have a thickness of from about 0.25 in. to about 2.0 in. and from about 0.5 in. to about 1.5 in.

The properties including, e.g., density, flexural modulus, and thickness, of the constraining layer can be selected for a particular application based upon a number of factors including, e.g., the size of the boat, the amount of vibration, and the frequency(s) to be damped. For increasingly greater amounts of vibration, for example, it is desirable to apply a damping article having a constraining layer with a relatively greater density, relatively larger dimension(s) (e.g., width, height, length or a combination thereof) or a combination thereof. Similarly, for larger boats, it may be desirable to increase various properties of the constraining layer including, e.g., the density, weight, dimension(s) or a combination thereof.

The damping layer includes a layer of foam that is resilient, i.e., capable of being compressed in response to a force and returning to its original form when the force is removed. Useful foam damping layers have a loss tangent of greater than about 0.2 in the range of 10 to 20,000, more preferably greater than about 0.3 in the range of 10 to 20,000 Hz, even more preferably greater than about 0.5 in the range of 10 to 20,000 Hz, and most preferably greater than about 1.0 in the range of 10 to 20,000 Hz at 23° C. Useful foam damping layers have a compressive storage modulus of from about 10⁵ to about 10¹⁰ dynes/cm² in the range of 10 to 20,000 Hz, more preferably from about 10⁶ to about 10⁹ dynes/cm² in the range of 10 to 20,000 Hz. Dynamic mechanical analysis was performed to determine the loss tangent and the compressive storage modulus of the damping layer. Loss tangent was determined on a Rheometrics RSA instrument in compression using frequency sweeps at various temperatures. A master curve was then constructed using a reference temperature of 23° C. The dependence of the loss tangent (dimensionless) and the compressive storage modulus (in units of dynes/cm²) as a function of frequency was obtained from this analysis.

Preferably the foam is a closed cell foam. Preferably the foam does not absorb greater than about 10% its weight in water. Suitable foams include natural rubber and synthetic rubbers. Examples of suitable synthetic rubbers include polycholorprene (neoprene), polyurethane, polyvinyl chloride, butadiene, polyolefins, polyesters, polyamides and copolymers thereof, and silicone, and elastomeric copolymers including, e.g., styrene-butadiene, acrylonitrile butadiene, ethylene-propylene-diene (EPDM), styrene-butadiene-styrene, styrene-isoprene-styrene and ethylvinyl acetate, and mixtures thereof including, e.g., a mixture of polyvinyl chloride, acrylonitrile butadiene and chloroprene. One example of a useful commercially available foam is polyvinyl chloride, acrylonitrile butadiene rubber and chloroprene (i.e., neoprene) rubber foam available under the trade designation Ensolite (Rubatex Corporation, Roanoke, Va.).

The substrate and the foam layer are bonded to each other to optimize the damping capabilities of the damping article. Preferably the substrate and the foam layer are in continuous contact with each other, i.e., substantially 100% surface contact. The substrate and the foam layer can be bonded to each other using a variety of mechanisms including, e.g., adhesive compositions and thermal bonding. In one embodiment, the substrate and the foam layer are bonded while in a mold cavity. A reactive polyurethane composition, preferably reinforced with a fibrous component, is injected into a mold cavity that includes a sheet of closed cell rubber foam. The inherent heat and pressure present in the mold during the molding operation cause the foam layer and the polyurethane to bond to each other resulting in a foam layer bonded to a polyurethane substrate.

When the damping article is bonded to a structure to be damped, the bond between the structure and the damping article is preferably continuous to optimize the damping function. The damping article can be bonded to a fiberglass boat hull according to a variety of methods including, e.g., applying an adhesive composition to an exposed surface of the foam layer, the structure to be damped or a combination thereof. Useful methods of applying adhesive compositions include, e.g., spraying and trowelling. The adhesive composition is selected to be compatible with the foam layer and the structure to be damped. For applications that may involve exposure of the adhesive to water, the adhesive composition is preferably capable of maintaining adhesion in the presence of moisture. Useful adhesive compositions include, e.g., pressure sensitive adhesive compositions, hot melt adhesive compositions, moisture cure urethane adhesives, epoxy adhesives, and spray contact adhesives. Suitable commercially available moisture cure urethane adhesive are available under the trade designations “5200”, “5200 FAST CURE” and “4200 FAST CURE” from Minnesota Mining and Manufacturing (St. Paul, Minn.).

A tacky resin impregnated fiberglass web can also be applied over a portion of the damping article and a portion of the structure to be damped. The web then cures to form a non-tacky hard layer surrounding the article, which can function to seal and protect the damping article from external sources (e.g., water). The non-tacky hard layer may further function to reduce movement of the constraining layer relative to the structure to be damped, and may also function to enhance the adhesion of the damping article to the structure to be damped. FIG. 3 illustrates a damping article 10 attached to a boat hull 16. A coating of cured resin 18 surrounds the article 10.

One method of selecting the location at which the damping article is to be attached to the boat hull includes first identifying the source that contributes the greatest amount of vibration to the structure and then applying the damping article to the structure in a location on the structure that is adjacent or above the source of vibration to damp the vibration.

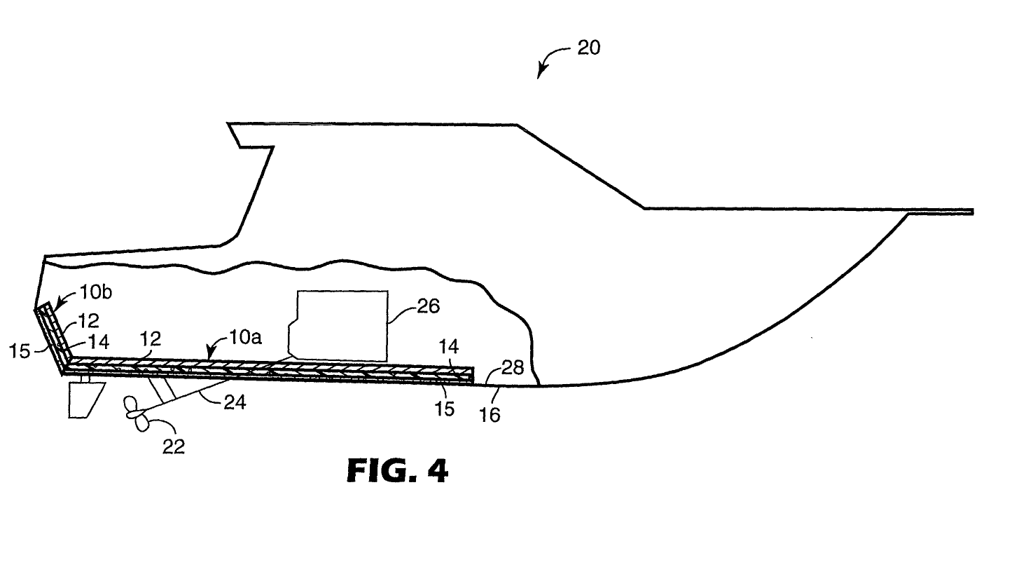

FIG. 4 illustrates a cross section of a portion of a boat 20 that includes a hull 16, a propeller 22 disposed below the boat hull 16, and a drive shaft 24 extending from the propeller 22 to the engine 26. The propeller 22 imparts a structural vibration to the boat hull 16. Damping articles 10a and 10b are attached with adhesive 15 to the interior surface 28 of the boat hull 16 at a location generally above the propeller, i.e., a source of vibration, to damp the vibration caused by the propeller 22.

The present invention provides damping articles wherein the properties of the substrate (i.e., constraining layer) may be controlled to provide a desired balance of physical properties such as density and flexural modulus. For example, the properties of the polyurethane foam comprising the substrate can be controlled to provide damping articles having the desired flexural modulus and density.

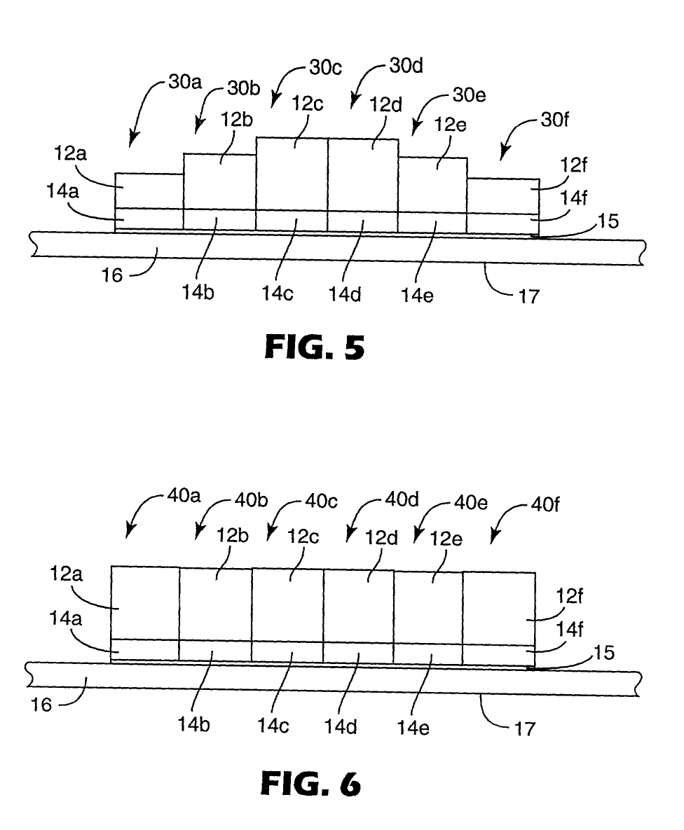

It may be desirable to attach a number of damping articles having a variety of different properties including, e.g., dimension, density and flexural modulus, to the structure to be damped. FIG. 5 illustrates a number of damping articles 30a-f attached with adhesive 15 to vibrating structure 16 having a source of vibration at 17. In FIG. 5 the thickness of the damping articles decreases as the distance away from the source of vibration 17 increases. Specifically, as shown in FIG. 5, damping articles 30c and 30d, adhered to the structure to be damped 16 near the point of vibration 17, have a greater thickness than the damping articles 30b, 30e, 30a, and 30f positioned a greater distance from the source of vibration 17.

FIG. 6 illustrates a number of damping articles 40a-40f attached with adhesive 15 to vibrating structure 16 having a source of vibration at 17. In FIG. 6 the density of the damping articles decreases as the distance away from the source of vibration 17 increases. That is, damping articles 40c and 40d, positioned near the source of vibration 17, have the greatest density. Damping articles 40b and 40e have a density that is less than the density of damping articles 40c and 40d. Damping articles 40a and 40f, positioned at the greatest distance from the source of vibration, have the lowest density. In FIG. 6 the damping articles 40a-40f have substantially the same thickness.

In other embodiments, the above-described substrate is bonded directly to a boat hull through a soft, flexible adhesive composition, i.e., in the absence of an intermediate foam layer. Suitable commercially available moisture cure urethane adhesive are available under the trade designations “5200”, “5200 FAST CURE” and “4200 FAST CURE” from Minnesota Mining and Manufacturing (St. Paul, Minn.).

The damping article has been described with respect to damping structural vibrations that occur in boat hulls, however, the damping article can be used to damp vibrations in a variety of structural composites including, e.g., fiberglass composites used in the manufacture of floatable water craft such as jet skis and water skis. The damping article can also be used to damp vibrations in other structures that experience vibrations including, e.g., airplanes, automobiles, space structures and the like.

The complete disclosures of all patents, patent applications and publications are incorporated herein by reference as if individually incorporated. Various modifications and alterations of this invention will become apparent to those skilled in the art without departing from the scope and spirit of this invention, and it should be understood that this invention is not to be unduly limited to the illustrative embodiments set forth herein.

What is claimed is:

1. A vibration damping article comprising:
a) a substrate having a density of at least about 10 lb/ft³ and a flexural modulus of at least about 110,000 psi; and
b) a foam layer bonded to said substrate, said foam layer having a loss tangent of greater than about 0.2 in the range of 10 to 20,000 Hz and a compressive storage modulus of from about 10⁵ dynes/cm² to about 10¹⁰ dynes/cm² in the range of 10 to 20,000 Hz.

2. The article of claim 1, wherein said substrate exhibits a flexural modulus of at least about 300,000 psi.

3. The article of claim 1, wherein said substrate exhibits a flexural modulus of at least about 400,000 psi.

4. The article of claim 1, wherein said substrate exhibits a flexural modulus of at least about 450,000 psi.

5. The article of claim 1, wherein said substrate has a density of at least about 20 lb/ft³.

6. The article of claim 1, wherein said substrate has a density of at least about 35 lb/ft³.

7. The article of claim 1, wherein said substrate has a density of at least about 40 lb/ft³.

8. The article of claim 1, wherein said substrate has a density of from about 20 lb/ft³ to about 80 lb/ft³.

9. The article of claim 1, wherein said substrate has a density of from about 60 lb/ft³ to about 70 lb/ft³.

10. The article of claim 1, wherein said substrate comprises a polymer.

11. The article of claim 1, wherein said substrate comprises polyurethane.

12. The article of claim 11, wherein said substrate comprises the reaction product of a mixture comprising an isocyanate and a polyether polyol.

13. The article of claim 11, wherein said substrate comprises a composite, said composite comprising a polyurethane and fiberglass.

14. The article of claim 1, wherein said substrate has a thickness of from about 0.125 in. to about 2 in.

15. The article of claim 1, wherein said substrate comprises a closed cell foam.

16. The article of claim 1, wherein said foam has a loss tangent of greater than about 0.3 in the range of 10 to 20,000 Hz.

17. The article of claim 1, wherein said foam has a compressive storage modulus of from about from about 10⁶ to about 10⁹ dynes/cm² in the range of 10 to 20,000 Hz.

18. The article of claim 1, wherein said foam comprises rubber.

19. The article of claim 1, wherein said foam comprises polyvinyl chloride, acrylonitrile butadiene rubber and neoprene.

20. The article of claim 1, wherein said foam comprises a closed cell foam.

21. The article of claim 1, wherein said foam has a thickness of from about 0.125 in. to about 1.0 in.

22. The article of claim 1 further comprising a composite comprising a resin and fiberglass, said foam layer being bonded to said composite.

23. The article of claim 1 further comprising a resin impregnated fiberglass web disposed on said substrate.

24. The article of claim 1, wherein said substrate comprises a composite comprising polyurethane and fiberglass, and said foam comprises polyvinylchloride, acrylonitrile rubber and neoprene.

25. A vibration damping article comprising:
a) a substrate comprising polyurethane and having a density of at least about 10 lb/ft³ and a flexural modulus of at least about 110,000 psi; and
b) a closed cell rubber foam bonded to said polyurethane substrate, said closed cell rubber foam having a loss tangent of greater than about 0.2 in the range of 10 to 20,000 Hz and a compressive storage modulus of from about 10⁵ dynes/cm² to about 10¹⁰dynes/cm² in the range of 10 to 20,000 Hz.

26. A boat hull comprising
a composite comprising resin and fiberglass; and
the article of claim 1 bonded to said composite.

27. The boat hull of claim 26 further comprising a resin impregnated fiberglass web disposed on said article.

28. A method of damping vibration, said method comprising:
a) applying an adhesive composition to at least one of:
a structure capable of vibrating; and
an article comprising:
i) a substrate having a density of at least about 10 lb/ft³ and a flexural modulus of at least about 110,000 psi; and
ii) a foam layer bonded to said substrate, said foam layer having a loss tangent of greater than about 0.2 in the range of 10 to 20,000 Hz and a compressive storage modulus of from about 10⁵ dynes/cm² to about 10¹⁰ dynes/cm² in the range of 10 to 20,000 Hz; and
b) contacting said structure with said article such that said article becomes bonded to said structure through said adhesive composition.

29. The method of claim 28, wherein said structure comprises a boat hull.

30. The method of claim 28, further comprising coating said article with a resin impregnated fiberglass web.

31. The method of claim 30, wherein said fiberglass web is in a form selected from the group consisting of a woven web and a nonwoven web.
